(19) United States
(12) Patent Application Publication
(10) Pub. No.: US 2018/0047001 A1
(43) Pub. Date: Feb. 15, 2018

(54) METHODS AND APPARATUS FOR ASSESSING A POTENTIAL LOCATION FOR AN AUTOMATED TELLER MACHINE

(71) Applicant: MasterCard International Incorporated, Purchase, NY (US)

(72) Inventor: Rakesh Tiwari, New Delhi (IN)

(21) Appl. No.: 15/655,029

(22) Filed: Jul. 20, 2017

(30) Foreign Application Priority Data
Aug. 12, 2016 (SG) 10201606718Y

(51) Int. Cl. G06Q 20/10; G06Q 30/02; G06Q 10/10; G01C 21/20; G07F 19/00

(52) U.S. Cl. CPC G06Q 20/1085; G01C 21/20; G07F 19/20; G06Q 10/10; G06Q 30/0201

(57) ABSTRACT

A computer implemented method of assessing a potential location for an automated teller machine is disclosed. The method comprises: receiving, at an ATM location assessment server, transaction data corresponding to transactions in a geographic area including the potential location; receiving, at the ATM location assessment server, an indication of a number of automated teller machines in the geographic area including the potential location; identifying, in a transaction identification module of the ATM location assessment server, transactions of a first transaction type in the transaction data; calculating, in a transaction metric calculation module of the ATM location assessment server, a first transaction metric for the transactions of the first transaction type; calculating, in a transaction density calculation module of the ATM location assessment server, a first transaction density using the first transaction metric and the indication of the number of existing automated teller machines in the geographic area; and calculating, in a score calculation module of the ATM location assessment server, a score for the potential location using the first transaction density.

### CROSS-REFERENCE TO RELATED APPLICATION

This application is a U.S. National Stage filing under 35 U.S.C. §119, based on and claiming benefit of and priority to SG Patent Application No. 10201606718Y filed Aug. 12, 2016.

### TECHNICAL FIELD AND BACKGROUND

The present disclosure relates to a method and system for processing data. In particular, it provides methods and systems for assessing potential locations for automated teller machines from transaction data.

Automated teller machines (ATMs) allow holders of payment cards to carry out transactions and banking operations without the requirement to enter a bank. One of the most common uses for an ATM is to withdraw cash. ATMs are typically operated and maintained by issuers of payment cards such as banking institutions or by service companies.

Currently most of the issuers or service companies providing new ATM installation services use point of interest data or location parameters such as estimated traffic per day, location popularity, weekend or week day traffic, the distance to the nearest ATM etc. to identify new locations to install ATMs.

### SUMMARY

According to a first aspect of the present invention, there is provided a computer implemented method of assessing a potential location for an automated teller machine. The method comprises receiving, at an ATM location assessment server, transaction data corresponding to transactions in a geographic area including the potential location; receiving, at the ATM location assessment server, an indication of a number of automated teller machines in the geographic area including the potential location; identifying, in a transaction identification module of the ATM location assessment server, transactions of a first transaction type in the transaction data; calculating, in a transaction metric calculation module of the ATM location assessment server, a first transaction metric for the transactions of the first transaction type; calculating, in a transaction density calculation module of the ATM location assessment server, a first transaction density using the first transaction metric and the indication of the number of existing automated teller machines in the geographic area; and calculating, in a score calculation module of the ATM location assessment server, a score for the potential location using the first transaction density.

In some embodiments the transactions of the first type comprise automated teller machine transactions. The first transaction metric may be a transaction count of transactions of the first transaction type and/or a total amount for transactions of the first transaction type.

In an embodiment the method further comprises: identifying, in the transaction identification module of the ATM location assessment server, transactions of a second transaction type in the transaction data; calculating, in the transaction metric calculation module of the ATM location assessment server, a second transaction metric for the transactions of the second transaction type; calculating, in a transaction density calculation module of the ATM location assessment server, a second transaction density using the second transaction metric and the indication of the number of existing automated teller machines in the geographic area, and wherein, the score for the potential location is calculated using the first transaction density and the second transaction density.

The transactions of the first type may comprise automated teller machine transactions and the transactions of the second type may comprise non-automated teller machine transactions.

The transactions of the first type may comprise transactions associated with payment cards issued for a country or territory including the potential location; and the transactions of the second type may comprise transactions associated with payment cards issued for a countries or territories not including the potential location.

The transaction data corresponding to transactions in a geographic area including the potential location may comprise transactions for a time interval. The time interval may be at least one year.

According to a second aspect of the present invention there is provided an apparatus for assessing a potential location for an automated teller machine. The apparatus comprises: a computer processor and a data storage device, the data storage device having a transaction identification module; a transaction metric calculation module; a transaction density calculation module; and a score calculation module comprising non-transitory instructions operative by the processor to: receive transaction data corresponding to transactions in a geographic area including the potential location; receive an indication of a number of automated teller machines in the geographic area including the potential location; identify transactions of a first transaction type in the transaction data; calculate a first transaction metric for the transactions of the first transaction type; calculate a first transaction density using the first transaction metric and the indication of the number of existing automated teller machines in the geographic area; and calculate a score for the potential location using the first transaction density.

According to a yet further aspect, there is provided a non-transitory computer-readable medium. The computer-readable medium has stored thereon program instructions for causing at least one processor to perform operations of a method disclosed above.

### BRIEF DESCRIPTION OF THE DRAWINGS

Embodiments of the invention will now be described for the sake of non-limiting example only, with reference to the following drawings in which:

FIG. 1 is a block diagram of a data processing system according to an embodiment of the present invention;

FIG. 2 is a block diagram of a data processing system that generates payment network data used in methods according to embodiments of the present invention

FIG. 3 is a block diagram illustrating a technical architecture of the apparatus according to an embodiment of the present invention;

FIG. 4 is a flowchart illustrating a method of assessing a potential location for an automated teller machine according to an embodiment of the present invention; and

FIG. 5 is a flowchart showing the calculation of a composite score for a potential automated teller machine location according to an embodiment of the present invention.

### DETAILED DESCRIPTION

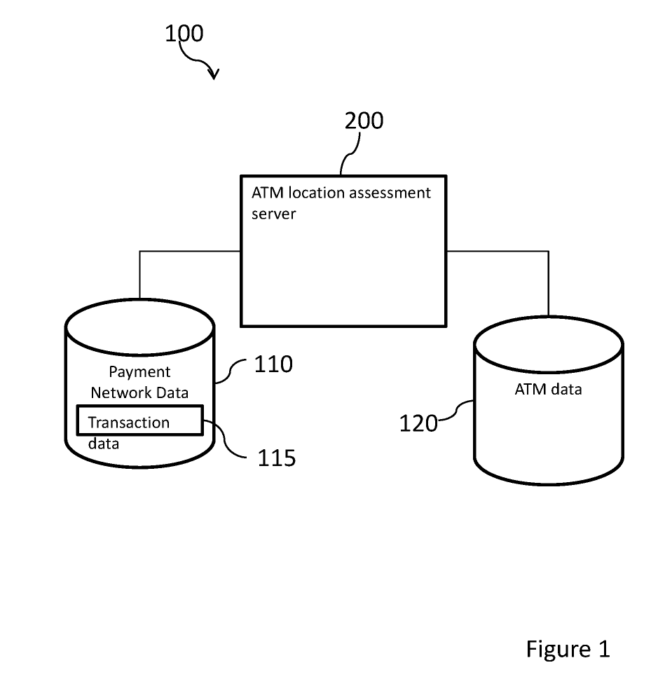

FIG. 1 is a block diagram showing a data processing system according to an embodiment of the present invention. The data processing system 100 comprises an automated teller machine (ATM) location assessment server 200. The ATM location assessment server 200 is coupled to a database which stores payment network data 110, and a database 120 storing ATM data.

The payment network data 110, and the ATM data 120 may be resident on different servers or server clusters. The servers may be either within a single data warehouse or distributed over a plurality of data warehouses. The data processed by the ATM location assessment server 200 may be retrieved from the servers, and cleaned and stored in a data warehouse prior to the analyses being conducted. Alternatively, the ATM location assessment server 200 may receive the data from servers which may be operated by the different providers.

The payment network data 110 comprises transaction data 115. The transaction data 115 comprises indications of transactions, which indicates information including the time and date of transactions; transaction amount; the card number of a payment card used for the transaction, or another number which uniquely identifies the card, without being the primary account number (PAN) itself; and the merchant or the ATM at which the transaction was carried out.

The ATM database 120 stores ATM locations and transactions captured at those ATMs. As mentioned above, the ATM database may be separate from the payment network data 110. Whenever a new ATM is set up, information relating to the new ATM, including for example its physical location and/or network address and/or an identifier such as a serial number, may be provided to the ATM database 120 by the ATM provider.

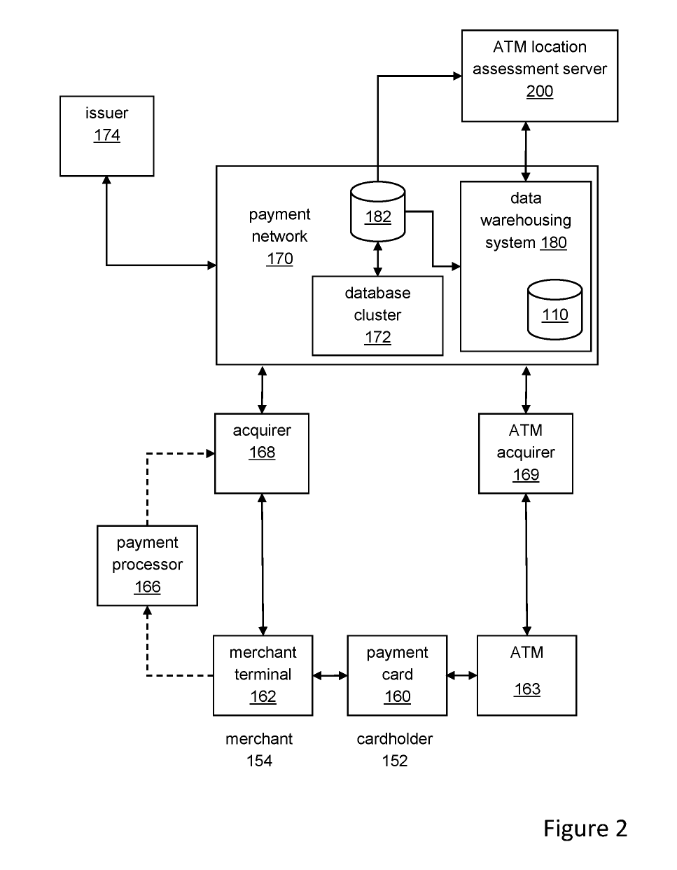

FIG. 2 shows an example of a data processing system which generates the payment network data 110. As shown in FIG. 2, the customer segment analysis server 200 receives transaction data from a payment network 170, such as the payment network operated by MasterCard.

The payment network 170 acts as an intermediary during a merchant transaction being made by a cardholder 152 using a payment card 160 at a merchant terminal 162 of a merchant 154 or an ATM transaction made by the cardholder 152 using an ATM 163. In particular, the cardholder 152 may present the payment card 160 to merchant terminal 162 of merchant 164 as payment for goods or services. The merchant terminal 162 may be a point of sale (POS) device such as a magnetic strip reader, chip reader or contactless payment terminal, or a website having online e-commerce capabilities, for example. A merchant 154 may operate one or a plurality of merchant terminals 162. The merchant terminal 162 communicates with an acquirer computer system 168 of a bank or other institution with which the merchant 154 has an established account, in order to request authorization for the amount of the transaction (sometimes referred to as ticket size) from the acquirer system 168. In some embodiments, if the merchant 154 does not have an account with the acquirer 168, the merchant terminal 162 can be configured to communicate with a third-party payment processor 166 which is authorised by acquirer 168 to perform transaction processing on its behalf, and which does have an account with the acquirer entity. The ATM 163 communicates with an ATM acquirer computer system 168 of a bank or financial institution which manages the ATM 163. The processing of the transaction by the ATM acquirer computer system 169 is carried out in an analogous manner to the processing carried out by the acquirer 168 for transactions at the merchant 154.

The acquirer system 168 or the ATM acquirer system 169 routes the transaction authorization request from the merchant terminal 162 or ATM 163 to computer systems of the payment network 170. The transaction authorization request is then routed by payment network 170 to computer systems of the appropriate issuer institution (e.g., issuer 174) based on information contained in the transaction authorization request. The issuer institution 174 is authorised by payment network 170 to issue payment devices 160 on behalf of customers 152 to perform transactions over the payment network 170. Issuer 174 also provides funding of the transaction to the payment network 170 for transactions that are approved.

The computer systems of the issuer 174 analyse the authorization request to determine the account number submitted by the payment card 160, and based on the account number, determine whether the account is in good standing and whether the transaction amount is covered by the cardholder's account balance or available credit. Based on this, the transaction can be approved or declined, and an authorization response message transmitted from issuer 174 to the payment network 170, which then routes the authorization response message to the acquirer system 178. The acquirer system 178, in turn, sends the authorization response message to merchant terminal 162 or the ATM. If the authorization response message indicates that the transaction is approved, then the account of the merchant 154 (or of the payment processor 166 if appropriate) is credited by the amount of the transaction following subsequent clearing and settlement processes, or for the case of an ATM transaction, the cardholder is allowed to make a cash withdrawal and the cardholder's account is debited accordingly.

During each authorization request as described in the previous paragraphs, the payment network 170 stores transaction information in a transactions database 110 accessible via a database cluster 172. The database cluster 172 may comprise one or more physical servers. In some embodiments, the transactions database 110 may be distributed over multiple devices which are in communication with one another over a communications network such as a local-area or wide-area network. In some embodiments, the transactions database 110 may be in communication with a data warehousing system 180 comprising a data warehouse database 182 which may store copies of the transaction data, and/or cleaned and/or aggregated data which are transformed versions of the transaction data.

Transaction records (or aggregated data derived therefrom) may be directly accessible for the purposes of performing analyses, for example by the customer segment analysis server 200, from transactions database 110. Alternatively, or in addition, the transaction records (or aggregated data derived therefrom) may be accessed (for example, by the customer segment analysis server 200) from the data warehouse database 182. Accessing the transaction records from the data warehouse database 182, instead of the transactions database 110, has the advantage that the load on the transactions database 110 is reduced.

The transaction records may comprise a plurality of fields, including acquirer identifier/card acceptor identifier (the combination of which uniquely defines the merchant); merchant category code (also known as card acceptor business code), that is, an indication of the type of business the merchant is involved in (for example, a gas station); cardholder base currency (i.e., U.S. Dollars, Euros, Yen, etc.); the transaction environment or method being used to conduct the transaction; the transaction type; card identifier (e.g., card number); time and date; location (full address and/or GPS data); transaction amount (also referred to herein as ticket size); terminal identifier (e.g., merchant terminal identifier or ATM identifier); and response code (also referred to herein as authorization code). Other fields may be present in each transaction record.

Each terminal identifier may be associated with a merchant 154, or an ATM 163. Typically, a particular merchant 154 will have a plurality of merchant terminal identifiers, corresponding to merchant terminals 162, associated with it.

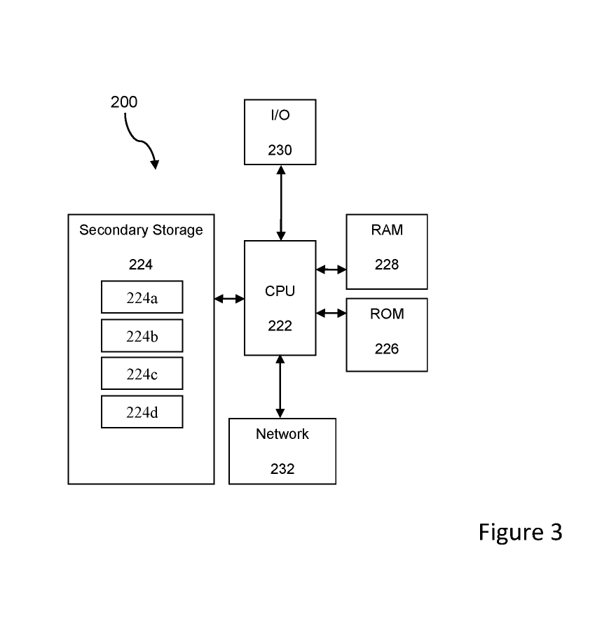

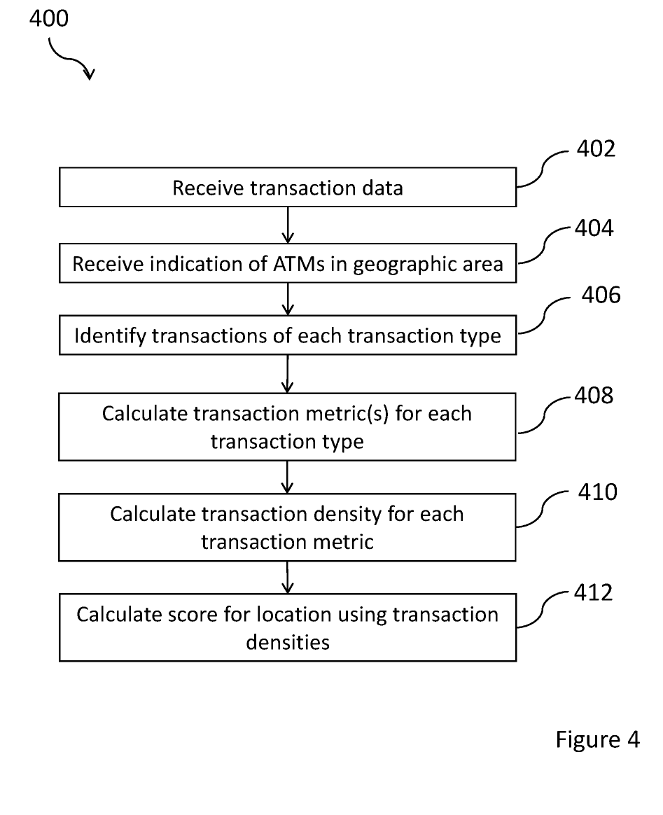

FIG. 3 is a block diagram showing a technical architecture of the ATM location assessment server 200 for performing an exemplary method 400 which is described below with reference to FIG. 4. Typically, the method 400 is implemented by a computer having a data-processing unit. The block diagram as shown FIG. 3 illustrates a technical architecture 200 of a computer which is suitable for implementing one or more embodiments herein.

The technical architecture 200 includes a processor 222 (which may be referred to as a central processor unit or CPU) that is in communication with memory devices including secondary storage 224 (such as disk drives), read only memory (ROM) 226, and random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a transaction identification module 224a, a transaction metric calculation module 224b, a transaction density calculation module 224c, and a score calculation module 224d comprising non-transitory instructions operative by the processor 222 to perform various operations of the method of the present disclosure. As depicted in FIG. 3, the modules 224a-224d are distinct modules which perform respective functions implemented by the ATM location assessment server 200. It will be appreciated that the boundaries between these modules are exemplary only, and that alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. It will also be appreciated that, while a software implementation of the modules 224a-224d is described herein, these may alternatively be implemented as one or more hardware modules (such as field-programmable gate array(s) or application-specific integrated circuit(s)) comprising circuitry which implements equivalent functionality to that implemented in software. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 200 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 200 to provide the functionality of a number of servers that is not directly bound to the number of computers in the technical architecture 200. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 200, at least one of the CPU 222, the RAM 228, and the ROM 226 are changed, transforming the technical architecture 200 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Various operations of the exemplary method 400 will now be described with reference to FIG. 4 in respect of assessing a potential location for an automated teller machine (ATM). It should be noted that enumeration of operations is for purposes of clarity and that the operations need not be performed in the order implied by the enumeration.

The method is carried out to assess a potential location for an ATM. The potential location may be country, a region of a country, a city or a specific area of a city.

In step 402, the ATM location assessment server 200 receives transaction data from the database storing the payment network data 110. The transaction data may be received in response to a query or request from the ATM location assessment server 200. The received transaction data relates to transactions in a geographic area including the potential location.

The transaction data relating to the geographic area may be identified using fields of the transaction data, for example geographical information specifying the latitude and longitude co-ordinates of a terminal or ATM where a transaction took place, a merchant postcode, or postcode associated with an ATM at which a transaction took place, city name information associated with either a merchant or ATM, or other information which allows the transaction data relating to a specific geographic region to be identified.

In step 404, ATM location assessment server 200 receives an indication of the existing ATMs located in the geographic area.

The information received in step 404 indicates the number of ATMs in the geographic area of interest.

In step 406, the transaction identification module 224a of the ATM location assessment server 200 identifies transactions to be used in the following analysis. The transaction identification module 224a may identify ATM transactions which occurred during an analysis period. The transaction identification module 224a may identify may identify types of transaction such as domestic ATM transactions; cross border ATM transactions; domestic non-ATM transactions; and cross border non-ATM transactions. Transactions may be identified as ATM transactions or non-ATM transactions using merchant identifiers or terminal identifiers.

Transactions may be identified as cross-border transactions or domestic transactions from an indication of card issuing country in the transaction data. If the card issuing country is the same as the country of the geographic location then the transaction is determined to be a domestic transaction. If the card issuing country is different from the country of the geographic location the transaction is determined to be a cross border transaction. Information on the country of card origination, card type, transaction amount etc. may be used in the analysis.

The analysis period may be selected as a period greater than one year, for example two years. A period greater than one year can be selected in order to even out possible seasonal variations may occur for periods of less than one year. Further a period of two years may also be beneficial to even out other economic variations.

In step 408, the metric calculation module 224b of the ATM location assessment server 200 calculates transaction metrics for each type of transaction. The transaction metrics may be for example the total number of transactions of a given type, or the total value of transactions of a given type.

In step 410, the transaction density calculation module 224c of ATM location assessment server 200 calculates a transaction density using each of the transaction metrics calculated in step 408. The transaction density is calculated by dividing the transaction metrics such as the total number of transactions or the total amount for transactions of a given type by the number of existing ATMs in the geographic area. The transaction density thus gives an indication of the number of transactions or the total transaction amount per ATM in the area.

In step 412, the score calculation module 224d of the ATM location assessment server 200 calculates a score for the location using the transaction densities calculated in step 410. The score may be calculated by multiplying each of the transaction densities by a weight. In some embodiments a single score is calculated for each location. The weights may be used to ensure that ATM transactions make a larger contribution than non-ATM transactions. Further since cross border transactions are often more profitable than domestic transactions, cross border transactions may have a higher weighting in the score.

In some embodiments, separate scores may be calculated for different types of transaction such as ATM transactions and non-ATM transactions.

It is envisaged that embodiments of the invention may be used to calculate scores for a number of different candidate ATM locations and based on the resulting scores locations for new ATMs may be selected.

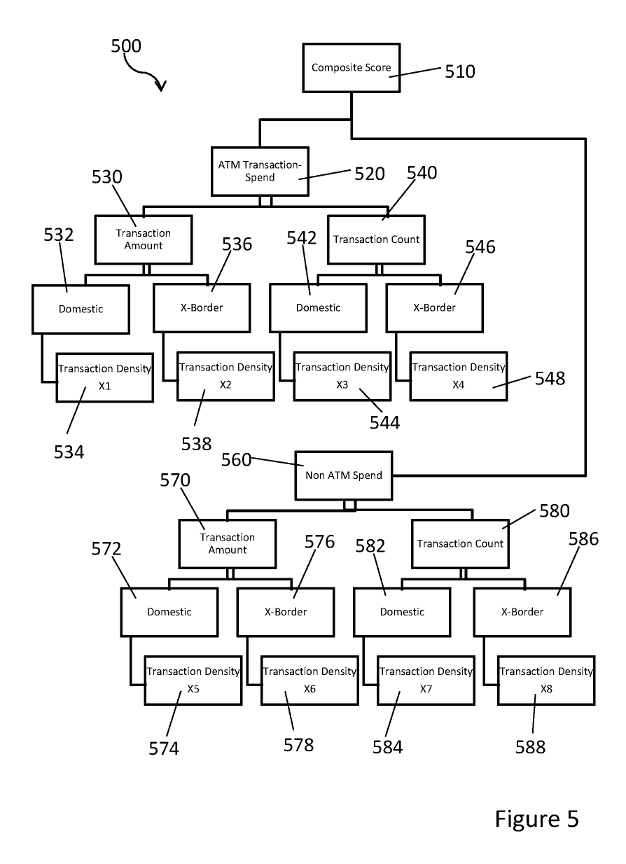

FIG. 5 is a flowchart showing the calculation of a composite score for a potential automated teller machine location according to an embodiment of the present invention. As shown in FIG. 5, the method 500 involves calculating a composite score 510.

The transactions within the geographic area for an analysis period are split into ATM transactions 520 and non-ATM transactions 560.

For ATM transactions, a transaction amount 530 and a transaction count 540 are determined. The transaction amount 530 is split into a domestic transaction amount 532 and a cross-border transaction amount 536. A transaction density 534 for the domestic part of the transaction amount is calculated by dividing the domestic transaction amount 532 by the number of ATMs in the area. This transaction density 534 is denoted as X1. A transaction density 538 is calculated by dividing the cross border transaction amount 536 by the number of ATMs in the area. This transaction density is denoted as X2.

Similarly, the transaction count 540 is split into a domestic transaction count 542 and a cross-border transaction count 546. A transaction density 544 for the domestic part of the transaction count is calculated by dividing the domestic transaction count 542 by the number of ATMs in the area. This transaction density 544 is denoted as X3. A transaction density 548 is calculated by dividing the cross border transaction count 546 by the number of ATMs in the area. This transaction density is denoted as X4.

Transaction densities are calculated in a similar manner for non-ATM transactions 560 as follows. A transaction amount 570 and a transaction count 580 are determined. The transaction amount 570 is split into a domestic transaction amount 572 and a cross border transaction amount 576. A transaction density 574 for the domestic part of the transaction amount is calculated by dividing the domestic transaction amount 572 by the number of ATMs in the area. This transaction density 574 is denoted as X5. A transaction density 578 is calculated by dividing the cross border transaction amount 576 by the number of ATMs in the area. This transaction density is denoted as X6.

Similarly, the transaction count 580 is split into a domestic transaction count 582 and a cross-border transaction count 586. A transaction density 584 for the domestic part of the transaction count is calculated by dividing the domestic transaction count 582 by the number of ATMs in the area. This transaction density 584 is denoted as X7. A transaction density 588 is calculated by dividing the cross border transaction count 586 by the number of ATMs in the area. This transaction density is denoted as X8.

The transaction densities are then used to calculate a score according to the following formula:

$$\frac{\begin{matrix}( W 1 * X 1 ) + ( W 2 * X 2 ) + ( W 3 * X 3 ) + ( W 4 * X 4 ) + ( W 5 * X 5 ) + \\ ( W 6 * X 6 ) + ( W 7 * X 7 ) + ( W 8 * X 8 )\end{matrix}}{W 1 + … + W 8}$$

Where W1, W2 . . . W8 are weights. The weights may be selected such that ATM transactions have a greater influence on the score than non-ATM transactions. Similarly the weights also be selected to take into account the profitability of different transaction types.

As described above, embodiments of the present invention allow assessment of potential locations for ATMs. If the transaction density is high then there is a compelling reason to place a new ATM at a location. Transaction data would enable the ability to visualize transactional density around proposed new sites. A composite score based on transaction density and value would help prioritizing the locations. The calculation of transaction density may be based on transaction count, transaction amount or a combination of the two.

Whilst the foregoing description has described exemplary embodiments, it will be understood by those skilled in the art that many variations of the embodiment can be made within the scope and spirit of the present invention.

1. A computer implemented method of assessing a potential location for an automated teller machine, the method comprising
receiving, at an ATM location assessment server, transaction data corresponding to transactions in a geographic area including the potential location;
receiving, at the ATM location assessment server, an indication of a number of automated teller machines in the geographic area including the potential location;
identifying, in a transaction identification module of the ATM location assessment server, transactions of a first transaction type in the transaction data;
calculating, in a transaction metric calculation module of the ATM location assessment server, a first transaction metric for the transactions of the first transaction type;
calculating, in a transaction density calculation module of the ATM location assessment server, a first transaction density using the first transaction metric and the indication of the number of existing automated teller machines in the geographic area; and
calculating, in a score calculation module of the ATM location assessment server, a score for the potential location using the first transaction density.

2. A method according to claim 1, wherein the transactions of the first type comprise automated teller machine transactions.

3. A method according to claim 1, wherein the first transaction metric is a transaction count of transactions of the first transaction type.

4. A method according to claim 1, wherein the first transaction metric is a total amount for transactions of the first transaction type.

5. A method according to claim 1, further comprising:
identifying, in the transaction identification module of the ATM location assessment server, transactions of a second transaction type in the transaction data;
calculating, in the transaction metric calculation module of the ATM location assessment server, a second transaction metric for the transactions of the second transaction type;
calculating, in a transaction density calculation module of the ATM location assessment server, a second transaction density using the second transaction metric and the indication of the number of existing automated teller machines in the geographic area, and
wherein, the score for the potential location is calculated using the first transaction density and the second transaction density.

6. A method according to claim 5, wherein transactions of the first type comprise automated teller machine transactions and transactions of the second type comprise non-automated teller machine transactions.

7. A method according to claim 5, wherein transactions of the first type comprise transactions associated with payment cards issued for a country or territory including the potential location; and transactions of the second type comprise transactions associated with payment cards issued for a countries or territories not including the potential location.

8. A method according to claim 1, wherein the transaction data corresponding to transactions in a geographic area including the potential location comprises transactions for a time interval.

9. A method according to claim 8 wherein the time interval is at least one year.

10. A non-transitory computer readable medium having stored thereon program instructions that when executed cause a computer to perform a method of assessing a potential location for an automated teller machine, comprising:
receiving, at an ATM location assessment server, transaction data corresponding to transactions in a geographic area including the potential location;
receiving, at the ATM location assessment server, an indication of a number of automated teller machines in the geographic area including the potential location;
identifying, in a transaction identification module of the ATM location assessment server, transactions of a first transaction type in the transaction data;
calculating, in a transaction metric calculation module of the ATM location assessment server, a first transaction metric for the transactions of the first transaction type;
calculating, in a transaction density calculation module of the ATM location assessment server, a first transaction density using the first transaction metric and the indication of the number of existing automated teller machines in the geographic area; and
calculating, in a score calculation module of the ATM location assessment server, a score for the potential location using the first transaction density.

11. An apparatus for assessing a potential location for an automated teller machine, the apparatus comprising:
a computer processor and a data storage device, the data storage device having a transaction identification module; a transaction metric calculation module; a transaction density calculation module; and a score calculation module comprising non-transitory instructions operative by the processor to:
receive transaction data corresponding to transactions in a geographic area including the potential location;
receive an indication of a number of automated teller machines in the geographic area including the potential location;
identify transactions of a first transaction type in the transaction data;
calculate a first transaction metric for the transactions of the first transaction type;
calculate a first transaction density using the first transaction metric and the indication of the number of existing automated teller machines in the geographic area; and
calculate a score for the potential location using the first transaction density.

12. An apparatus according to claim 11, wherein the transactions of the first type comprise automated teller machine transactions.

13. An apparatus according to claim 11, wherein the first transaction metric is a transaction count of transactions of the first transaction type.

14. An apparatus according to claim 11, wherein the first transaction metric is a total amount for transactions of the first transaction type.

15. An apparatus according to claim 11, wherein:
the transaction identification module further comprises non-transitory instructions operative by the processor to: identify transactions of a second transaction type in the transaction data;
the transaction metric calculation module further comprises non-transitory instructions operative by the processor to: calculate a second transaction metric for the transactions of the second transaction type;
the transaction density calculation module further comprises non-transitory instructions operative by the processor to: calculate a second transaction metric for the transactions of the second transaction type; and
the score calculation module further comprises non-transitory instructions operative by the processor to: calculate a second transaction density using the second transaction metric and the indication of the number of existing automated teller machines in the geographic area, and the score for the potential location is calculated using the first transaction density and the second transaction density.

16. An apparatus according to claim 15, wherein transactions of the first type comprise automated teller machine transactions and transactions of the second type comprise non-automated teller machine transactions.

17. An apparatus according to claim 15, wherein transactions of the first type comprise transactions associated with payment cards issued for a country or territory including the potential location; and transactions of the second type comprise transactions associated with payment cards issued for a countries or territories not including the potential location.

18. An apparatus according to claim 11, wherein the transaction data corresponding to transactions in a geographic area including the potential location comprises transactions for a time interval.

19. An apparatus according to claim 18 wherein the time interval is at least one year.
